(19) United States
(12) Patent Application Publication
(10) Pub. No.: US 2011/0203114 A1
(43) Pub. Date: Aug. 25, 2011

(54) Safety Slice

(75) Inventor: Joseph Albert Hier, JR., Los Angeles, CA (US)

(73) Assignee: Joseph Albert Hier, JR., Los Angeles, CA (US)

(21) Appl. No.: 12/710,362

(22) Filed: Feb. 23, 2010

(51) Int. Cl. B26B 11/00

(52) U.S. Cl. 30/123

(57) ABSTRACT

The Safety Slice (FIG. 1a) is a cutting and serving utensil in one. It is a hand-held spatula-like apparatus with a handle (FIG. 2a) measuring 8 (eight) inches long, ¾ (three quarters) of an inch wide, and ¾ (three quarters) of an inch deep. There is a 45 degree downward bend in the handle at the 4 inch point (FIG. 2b). There is another 45 degree bend at the 8 (eight) inch point where the handle meets the base or spatula portion of the apparatus (FIG. 2c). The base or spatula portion (FIG. 4) is a flat rectangle measuring 4 (four) inches by 3½ (three and a half) inches by 1/16 (one sixteenth) of an inch. The base also has a rectangular portion “cut out” or “open” on the left side of the apparatus (FIG. 3) leaving ⅛ (one eighth) of an inch material strips along the front, back, and left side of the base. This is the cutting portion of the apparatus (FIG. 3). The whole base serves as a flat, cutting spatula.

### SPECIFICATION

The Safety Slice is a cutting and serving utensil in one. It is a hand held spatula-like apparatus with a handle, that both cuts and serves cakes, pies and other large square or rectangular desserts such as brownies, etc., without the need of sharp, dangerous knives or other dangerous and pointed cutting or serving utensils. This is an industry first in safety especially for use around children's birthdays, in busy kitchens, and for people with pain/grip issues.

### DRAWINGS

FIG. 1a is the top view of The Safety Slice.

FIG. 1b points to the convenient hanging notch in the top of the handle.

FIG. 2a is the handle from a side view of The Safety Slice.

FIG. 2b is the first 45 degree bend in the handle.

FIG. 2c is the second 45 degree bend where the handle meets the base.

FIG. 3a is the perspective view of The Safety Slice.

FIG. 3b Points to the cutting portion of the apparatus.

FIG. 4a is the front perspective view of The Safety Slice, pointing to the spatula portion.

FIG. 4b points to the three measurement marks for the multiple size cutting options.

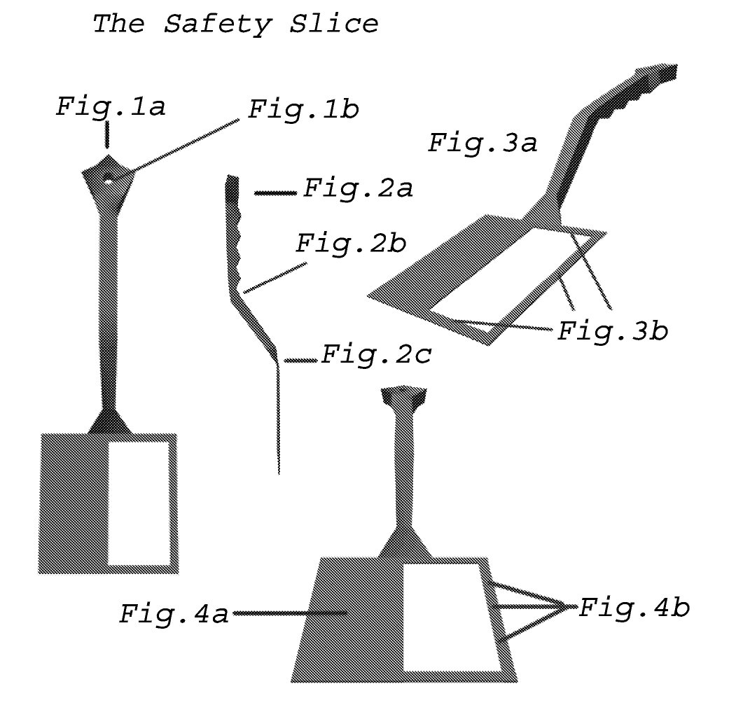

1. One cuts slices of cake by bearing down with the utensil on the bottom right side of a square cake. Then in one more motion, one turns the utensil toward the right, effectively slipping the spatula portion of the utensil under the cut piece of cake to lift and serve, thus cutting and serving the slice of cake.
This combination cutter and server eliminates the need for an unwieldy and often dangerous knife at the table, especially around children. The safety slice effectively cuts and serves the slice of cake with no need for a knife.
The safety slice cuts and serves the same size slice of cake every time. The left side of the utensil is like a stencil in that it is unmovable therefore cuts the same size and shape of slice every time. There are three convenient guide measurements along the cutting side of the apparatus to allow for a choice of four different slice sizes to be cut according to your liking. (FIG. 4b).
The Safety Slice can be made out of metal or heat resistant plastic. It will come in royal blue and hot pink.
The Safety Slice has ergonomic finger grips and has a convenient notch (FIG. 1b) in the top of the handle for hanging on a kitchen hook.
